(19) United States
(12) Patent Application Publication
(10) Pub. No.: US 2026/0211663 A1
(43) Pub. Date: Jul. 23, 2026

(54) Updating of a Vehicle Key for a Motor Vehicle

(71) Applicant: Bayerische Motoren Werke Aktiengesellschaft, Muenchen (DE)

(72) Inventors: Christian BUCHNER, Poing (DE); Kai HOESL, Iffeldorf (DE); Vlastimil ZWIEFELHOFER, Muenchen (DE)

(21) Appl. No.: 19/455,112

(22) Filed: Jan. 21, 2026

(30) Foreign Application Priority Data
Jan. 22, 2025 (DE) 10 2025 102 309.3

(51) Int. Cl. G06F 8/65; B60R 25/24; G06F 21/57

(52) U.S. Cl. CPC G06F 8/65; G06F 21/572; B60R 25/24; B60R 2325/108; G06F 2221/033

(57) ABSTRACT

An electronic key for a motor vehicle communicates wirelessly with the motor vehicle within a predetermined distance. Data updates for the vehicle key are provided on board the motor vehicle. The data updates are transmitted from the motor vehicle to the vehicle key. An assumption by the motor vehicle of a state in which the vehicle key will foreseeably remain within the above-mentioned distance is determined. The vehicle key is updated.

### CROSS REFERENCE TO RELATED APPLICATION

This application claims priority under 35 U.S.C. § 119 from German Patent Application No. DE 10 2025 102 309.3, filed Jan. 22, 2025, the entire disclosure of which is herein expressly incorporated by reference.

### BACKGROUND AND SUMMARY

The present invention relates to an electronic vehicle key for a motor vehicle. In particular, the invention relates to an updating of a vehicle key of this type.

A motor vehicle can be controlled by means of an electronic vehicle key. In particular, a central locking system or a drive motor can be secured by means of the vehicle key. The vehicle key and the motor vehicle communicate wirelessly with one another, and exchange predetermined cryptographic information for controlling a function of the motor vehicle.

For the improvement of security, for the retrofitting of new functions, or for the rectification of a security-related weak point, the vehicle key can be updated. To this end, data updates can be wirelessly transmitted to the vehicle key. Under certain circumstances, it is also necessary for an on-board control device of the motor vehicle to be updated, and for the updating of the vehicle key and the control device to be mutually attuned or synchronized. An operation of this type is customarily executed in a workshop or service center. Data updates can be communicated from an updating device to both the motor vehicle and the vehicle key, and the timing or content of updates can be mutually attuned.

However, a procedure of this type is complex, and requires either a special device or the presence of the motor vehicle and the vehicle key in a service center. A fundamental object of the present invention is the provision of an improved technology for the simplified updating of a wireless vehicle key for a motor vehicle. According to the invention, this object is fulfilled by the subject matter of the independent claims. Preferred embodiments are disclosed in the sub-claims.

An electronic vehicle key for a motor vehicle is designed to communicate wirelessly with the motor vehicle within a predetermined distance. According to a first aspect of the present invention, a method for updating a vehicle key of this type comprises steps for the provision of data updates for the vehicle key on board the motor vehicle; transmission of data updates from the motor vehicle to the vehicle key; determination of the assumption by the motor vehicle of a state in which the vehicle key will foreseeably remain within the above-mentioned distance; and updating of the vehicle key.

The method enables data updates to be communicated from the motor vehicle to the vehicle key. A special updating device for the provision of data updates is not required. Data updates can be provided in an arbitrary manner on board the motor vehicle, for example by the downloading thereof from an external entity. The external entity can exemplarily comprise an update server, which server is able to supply data updates for a multiplicity of motor vehicles or for the electronic vehicle keys thereof.

The above-mentioned state can include the maintenance of the vehicle key within the above-mentioned distance for a predetermined duration, which duration is dimensioned such that the updating of the vehicle key can be completed securely, even under unfavorable conditions. The vehicle key is preferably a dedicated electronic device, which device comprises a processing unit, an energy storage device and a wireless interface. According to an exemplary embodiment, updating can be executed within a time of approximately 1 second. The state of the motor vehicle is thus selected such that it is improbable that the vehicle key will communicate with the motor vehicle within this time.

The distance can encompass an interior of the motor vehicle, wherein it is determined that the vehicle key is located in the interior. In particular, the position of the vehicle key can be determined wirelessly. This determination can originate from the motor vehicle or from the vehicle key. According to one embodiment, an approximate position is determined with reference to the direction of a wireless signal received and the signal strength thereof. Preferably, to this end, directions and signal strengths of multiple signals between the motor vehicle and the vehicle key are determined. According to another embodiment, the position can be determined on the basis of distances on various wireless transmission links between the motor vehicle and the vehicle key. A distance can be determined on the basis of the propagation rate of radio waves. A technique of this type is known by the term “channel sounding”. Positional determination can be executed on the basis of various wireless communication technologies, for example Bluetooth (BT) or Bluetooth Low Energy (BLE), or ultra-wideband (UWB).

According to at least one embodiment, it is determined that the vehicle key is situated in a predetermined location in the motor vehicle. To this end, for example, the vehicle key can be accommodated in a locator which is provided for this purpose. According to one embodiment, this locator is a charging cradle in which an energy storage device of the vehicle key can be charged. By means of the power connection, a communication with the vehicle key can be enabled. Further preferably, the vehicle key is stored in a location from which wireless communication is enabled by means of a technology which bridges only a short distance. An exemplary technology of this type is near-field communication (NFC), which technology is only effectively applicable over a few centimeters. According to a further embodiment, a mechanical lock is provided, in which a mechanical vehicle key bit is inserted. If the vehicle key is able to release the lock, the position thereof on board the motor vehicle is known accordingly.

The above-mentioned state can comprise a travel of the motor vehicle at a predetermined minimum speed. The motor vehicle is thus self-powered, and is driven by a drive motor. In this state, no communication is required between the motor vehicle and the vehicle key for the start-up of the drive motor. As the motor vehicle is in motion, no control function for the opening of a vehicle door or vehicle hatch by means of the vehicle key is required. A search function, wherein a communication is established between the motor vehicle and the vehicle key, is likewise not required. In this state, it can thus be assumed that no interaction occurs between the motor vehicle and the key. The minimum speed can thus be selected such that any opening of a vehicle door is sufficiently improbable. In practice, the minimum speed can be, for example, approximately 30 km/h or approximately 50 km/h. For precautionary purposes only, this state can comprise travel below a predetermined maximum speed. The maximum speed can be, for example, approximately 80 km/h or approximately 100 km/h.

According to at least one embodiment, the above-mentioned state can be governed by further requirements. For example, it can be required that the motor vehicle is driving out of town, is not situated on a motorway, or is traveling on a road on which any anticipated longitudinal and/or transverse acceleration will remain below a stipulated threshold value thus assigned.

The vehicle key preferably comprises a first and a second memory. In the first memory, program code for controlling the vehicle key is saved. Data updates can then be saved in a second memory, wherein updating comprises a switchover from the first memory to the second memory. A start-up process of the processing unit of the vehicle key (cold start, or boot-up) can also be executed. It can thus be ensured that the actual update is executed within the shortest possible time. By the provision of two mutually independent memories, it is possible to revert to the first memory, in the event that a problem occurs in conjunction with the execution of program code in the second memory. For a subsequent update, the roles of the first and second memories can be mutually interchanged.

According to at least one embodiment, only a single memory is provided, wherein data updates are directly logged in this memory. However, this process can be of a relatively prolonged duration, according to a realistic embodiment, for example, of the order of approximately 10 seconds. According to at least one embodiment, the vehicle key comprises an internal memory, in which program code must be located in order to enable the execution thereof, and an external memory, in which data updates are temporarily logged. The transfer of data updates from the external memory to the internal memory can also be complex or time-consuming.

It is further preferred that the electronic vehicle key is configured to execute a cryptographic exchange process with the motor vehicle via the wireless communications link. To this end, in particular, an asymmetric cryptographic authentication process can be provided. In conjunction with updating, on the vehicle key side, it can be determined that data updates which are to be transmitted, or which have already been transmitted, are valid. This can be executed, wherein a check of a cryptographic signature of the data updates is completed. In the event of the failure of this check, any update can be refused. Actual updating of the vehicle key can be executed further to the transmission by the motor vehicle of an updating signal to the vehicle key. The updating signal can also be cryptographically protected, and the authenticity thereof can be cryptographically checked by the vehicle key. In particular, the updating signal can carry a cryptographic signature, and the signature can be cryptographically checked by the electronic vehicle key.

Updating of the vehicle key can be subject to further conditions. According to one embodiment, it is determined that an energy storage device of the vehicle key assumes a predetermined performance capability. The energy storage device is customarily embodied as a battery or an accumulator, wherein an open-circuit voltage thereof can be indicative of a state-of-charge. Accordingly, if the state-of-charge lies below a predetermined threshold value, the energy storage device fails to assume a predetermined performance capability, such that any updating of the vehicle key can be deferred or refused. It is also possible for a prevailing temperature in the vicinity of the vehicle key to be considered. The higher the temperature, the more effective the performance of an electrochemical energy storage device of the vehicle key can be. According to one embodiment, updating can only be executed in the event that the temperature in the vicinity of the vehicle key exceeds a predetermined threshold value. According to another embodiment, the requisite performance capability of the energy storage device can be determined on the basis of temperature. Alternatively, the performance capability of the energy storage device can be determined on the basis of temperature.

According to at least one embodiment, a control device of the motor vehicle is updated in a synchronized manner with the vehicle key. Synchronization comprises a predetermined temporal sequence of updating steps of the vehicle key and of the control device. The vehicle key and the control device can thus be updated simultaneously, in a synchronous stepwise manner, in an interlocking manner or in another predetermined sequence. It can thus be ensured that the vehicle key and the control device are mutually compatible, both before and after updating. Data updates for the control device can be obtained from the same source as data updates for the vehicle key. Alternatively, data can be obtained from different sources.

It can be determined that a further vehicle key for the motor vehicle is situated within the above-mentioned distance. The further vehicle key can also be updated. The same procedure can be executed as described herein with respect to the first vehicle key. Two or more vehicle keys of the motor vehicle can be synchronously updated. For specific updates, it can be required that all valid vehicle keys are updated in a simultaneous manner. In this case, updating can only be executed in the event that all vehicle keys within the predetermined distance from the vehicle have been identified.

According to at least one embodiment, an on-board control device of a motor vehicle comprises a unit for the supply of data updates for an electronic vehicle key for the motor vehicle; a wireless interface for communicating with the vehicle key over a predetermined distance; and a processing unit. The processing unit is designed to communicate data updates to the vehicle key; to determine the assumption by the vehicle of a predetermined state, in which the vehicle key will foreseeably remain within the above-mentioned distance; and to communicate an updating signal to the vehicle key.

The processing unit is preferably designed for the complete or partial execution of a method described herein. To this end, the processing unit can be embodied electronically, and can exemplarily comprise an integrated circuit, a programmable logic module or a programmable microcomputer. The method can be embodied in the form of a configuration or in the form of a computer program product having program code means for the processing unit. The configuration or the computer program product can be saved on a computer-readable data medium. Features or advantages of the method can be translated to the device, or vice versa.

The control device and the vehicle key are preferably designed for the mutual execution of a cryptographically secured communication. In particular, one of the devices can be designed to check the authenticity of a message from the respective other device. To this end, the message can carry a cryptographic signature. The signature can be set up on the basis of an asymmetric cryptographic method, which method provides for a public and a private cryptographic key for each subscriber. The public key of a subscriber is known to the respective other subscriber, whereas the private key is only known to the subscriber themselves. An encryption which has been executed using a private key of a subscriber, by means of a corresponding operation, can be reversed using the private key, and vice versa.

The processing unit is preferably designed to determine the assumption by the motor vehicle of a further predetermined state, before data updates are communicated to the vehicle key. It can thus be additionally ensured that communication is not compromised by an operation of the vehicle key involving the motor vehicle, or vice versa.

According to at least one embodiment, a motor vehicle comprises a control device described herein. In particular, the motor vehicle can comprise a motorcycle or a passenger vehicle. In the interests of simplification, it is also described herein that the motor vehicle communicates with the vehicle key whereas, strictly speaking, communication is executed between the control device of the motor vehicle and the vehicle key.

According to at least one embodiment, an electronic vehicle key is proposed, which key is designed for the wireless control of a predetermined security function of the motor vehicle. In particular, the security function can comprise the unlocking of a vehicle door or vehicle hatch, or the start-up of a drive motor. The vehicle key comprises a wireless interface for communicating with the motor vehicle over a predetermined distance; a memory for the storage of program code for controlling the vehicle key; and a processing unit. The processing unit is designed to receive data updates for the vehicle key; to receive an updating signal from the motor vehicle; and to execute the updating of program code on the basis of data updates thus received.

Updating can comprise a replacement or modification of existing program code. Data updates received and/or an updating signal received can be cryptographically verified. In the event of the failure of a verification, it is not possible for the update to be executed. The electronic vehicle key preferably comprises a first and a second memory, or the memory is subdivided into two mutually independent segments, one of which can contain an active program code, and the other of which can contain data updates.

According to at least one embodiment, a system comprises a motor vehicle described herein, and a vehicle key described herein. The system can moreover comprise a central entity for the provision of data updates for the vehicle key. Data updates for the control device of the motor vehicle can be supplied thereby, or by another central entity of the system.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system; and

FIG. 2 illustrates a flow diagram of a method.

### DETAILED DESCRIPTION OF THE DRAWINGS

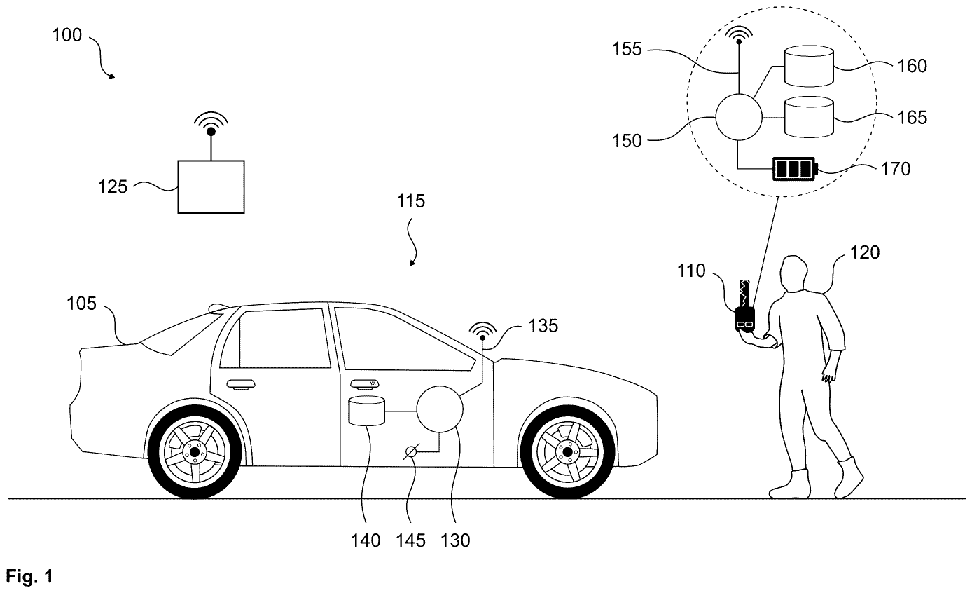

FIG. 1 shows a system 100 having a motor vehicle 105 and a vehicle key 110. A control device 115 is provided on board the motor vehicle 105. The motor vehicle 105 or the control device 115 can communicate wirelessly with the vehicle key 110, in order to control a function of the motor vehicle 105 by means of the vehicle key 110. The function can particularly comprise a locking or unlocking of a vehicle door or hatch, or a start-up of a drive motor. A user 120 can carry the vehicle key 110 on their person, in order to enable the control of a function of the motor vehicle 105. Optionally, the system 100 additionally comprises an updating service 125, which service is designed to supply data updates for the vehicle key 110 and/or for a control device 115 of the motor vehicle 105. According to a further embodiment, different updating services 125 are provided for the motor vehicle 105 or control device 115 and for the vehicle key 110. An updating service 125 is designed to communicate wirelessly with the motor vehicle 105.

The control device 115 comprises a processing unit 130, at least one wireless interface 135, preferably a memory 140, and further preferably an on-board interface 145. The wireless interface 135 is designed to communicate with the vehicle key 110 and/or with the updating service 125. Customarily, different wireless interfaces 135 are provided for this purpose. Accordingly, communication with the updating service 125 can be preferably executed by means of WiFi or cellular radio. Conversely, communication with the vehicle key 110 can be executed by means of BT, BLE, UWB or NFC. According to some embodiments, a communication between the control device 115 and the updating service 125 or the vehicle key 110 can optionally be executed by means of different radio technologies.

Data updates received by the control device 115 from the updating service 125 can be buffered in the memory 140. The processing unit 130 can check data received for completeness, accuracy and/or authenticity. A known cryptographic method can be employed for this purpose, in particular a method which operates on the basis of an asymmetric cryptographic authentication. Via the on-board interface 145, the control device 115 can control a function of the motor vehicle 105, in particular a security function of the motor vehicle 105, in response to a request from the vehicle key 110.

The vehicle key 110 comprises a processing unit 150, a wireless interface 155, and at least one first memory 160. According to the embodiment represented, additionally, a second memory 165 is provided, wherein the two memories 160, 165, further preferably, are equal-ranking. In particular, in each case, the memory is preferably an internal memory of the vehicle key 110. Exemplarily, the memories 160, 165 can be comprised by a microcontroller or system-on-a-chip (SoC), which system also comprises the processing unit 150 and, optionally, the wireless interface 155. Further optionally, only one physical memory is provided, which memory can be logically or administratively subdivided into the first memory 160 and the second memory 165. Program code which can be executed on the processing unit 150, in order to confer the predetermined functionality upon the vehicle key 110, is accommodated in one of the memories 160, 165. The respective other memory 160, 165 can be occupied by data updates. Data updates can be processed for the incorporation therein of updated program code for the operation of the vehicle key 110. For the updating of the vehicle key 110 from an existing program code to data updates, a switchover can be executed from one of the memories 160, 165 to the other. This switchover is customarily executed in the context of a restart of the processing unit 150.

The energy storage device 170 is customarily electrochemically embodied, and can be chargeable or non-chargeable. In both cases, the energy storage device 170 supplies electrical energy for operating other components of the vehicle key 110. The processing unit 150 can be designed to determine a performance capability of the energy storage device 170. In particular, this performance capability can be determined on the basis of an open-circuit voltage of the energy storage device 170. Performance capability can be determined with reference to a prevailing temperature, which temperature can also be determined by the processing unit 150. To this end, a temperature sensor can be provided, which sensor is optionally incorporated in the above-mentioned SoC.

It is proposed that, for updating the vehicle key 110, data updates are firstly obtained by the motor vehicle 105 from the updating service 125 and are buffered in the memory 140. Under predetermined conditions, data updates can be wirelessly communicated to the vehicle key 110. Under further predetermined conditions, an updating of the vehicle key 110 can be executed on the basis of data updates. If required, updating of the vehicle key 110 can be synchronized with the updating of the control device 115, or of another control device on board the motor vehicle 105.

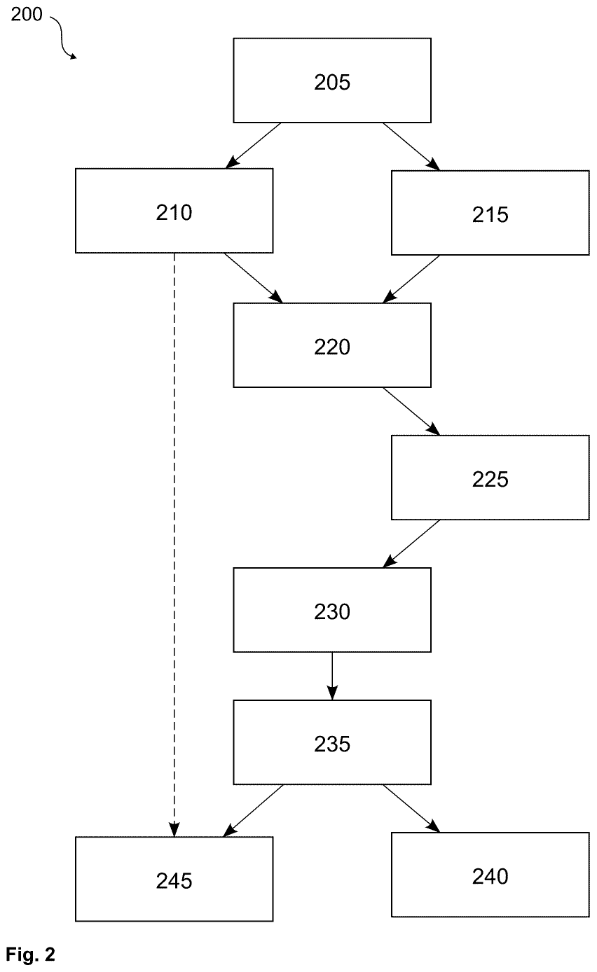

FIG. 2 shows a flow diagram of an exemplary method 200 for updating a vehicle key 110.

In a step 205, data updates for the vehicle key 110 are received from the updating service 125. A request for the transmission of data updates can originate from the updating service 125. Data updates are provided for the vehicle key 110; under certain circumstances, further data updates are assigned to an on-board control device 115 of the motor vehicle 105.

If this is the case, data updates for the control device 115 can be prepared for updating in a step 210. The control device 115 can be prepared for updating. To this end, prepared data updates can be logged in a predetermined memory segment of the control device 115.

In a concurrent step 215 thereto, data updates for the vehicle key 110 can firstly be saved on board the motor vehicle 105 only. In particular, data updates can be saved in the memory 140 of the control device 115.

In a step 220, a first predetermined state of the motor vehicle 105 can be detected. This state is selected such that a communication of data updates from the motor vehicle 105 or the control device 115 to the vehicle key 110 can be executed in the most unimpaired and complete manner possible. This state can be characterized, for example, wherein the vehicle key 110 is located within a predetermined distance from the control device 115. To this end, a distance measurement can be executed via the wireless interfaces 135, 155. It is preferably determined that the vehicle key 110 is situated on board the motor vehicle 105, in particular in an interior of the motor vehicle 105. To this end, a relative position of the vehicle key 110 vis-à-vis the motor vehicle 105 can be determined. This position can be determined on the basis of distances between different transceivers of the motor vehicle 105 or of the control device 115 and the vehicle key 110 or the interface 155. Alternatively, a predetermined position of the vehicle key 110 on board the motor vehicle 105 can be compelled, wherein the vehicle key 110 executes a predetermined function, which function can only be executed in the predetermined position. This function can comprise, for example, communication by NFC, wherein an NFC transceiver of the control device 115 or of the motor vehicle 105 is arranged in sufficient proximity to the desired position. This position can be located in the region of a charging cradle into which the vehicle key 110 can be inserted, in order to enable the inductive charging of the energy storage device 170 by the motor vehicle 105.

The above-mentioned state can moreover be determined by reference to a driving state of the motor vehicle 105. This state can thus comprise an observation by the motor vehicle 105 of a predetermined minimum speed and/or of a predetermined maximum speed. It can also be required that the motor vehicle 105 is situated on a carriageway of a predetermined road class, that no more or no fewer than a predetermined number of persons are present on board the motor vehicle 105, etc. Further optionally, the user 120 on board the motor vehicle 105 can be requested to consent to a communication of data updates from the motor vehicle 105 to the vehicle key 110. In the absence of the communication of this consent by the user 120, the method 200 can be terminated at this point.

Otherwise, in a step 225, data updates can be transmitted from the memory 140 to the vehicle key 110. Depending upon the communication technology employed, prevailing transmission conditions, a volume of data updates and the processing capacities of the processing units 130 and 150, this transmission can be of variable duration. It is preferred that a duration is determined, which duration is anticipated under the assumption of poor conditions or marginal conditions. The state in step 220 is preferably selected such that it can be assumed, with a predetermined probability, that this state will at least be maintained over the duration thus determined. In the event that the transmission of data updates in step 225 nevertheless fails, the method 200 can return to step 220.

In a step 230, it can be detected that a second predetermined state of the motor vehicle 105 is achieved. In a similar manner to steps 220, 225, in step 230, the state of the motor vehicle 105 is preferably established such that the vehicle key 110 and the control device 115 are available for updating, and it can be assumed, with a predetermined probability, that corresponding conditions will continue to prevail at least over a duration which is required for the execution of updating under unfavorable conditions. Optionally, a consent of the user 120 to updating can be obtained.

In a step 235, a check can be executed as to whether the vehicle key 110 is ready for updating. To this end, for example, a check can be executed as to whether the energy storage device 170 continues to assume a sufficient performance capability, or whether a self-test of the vehicle key 110 indicates that it is possible for data updates transmitted to be successfully installed.

If this is the case, the vehicle key 110 can be updated in a step 240. If data updates have previously been uploaded, checked, extracted and/or prepared in the memory 160, 165, it is possible for actual updating to require only a duration of approximately 1 second. If two memories 160, 165 having equal entitlements are not employed, updating can also be of a longer duration, which duration is customarily measured in a range of seconds.

Synchronously herewith, in a step 245, an on-board control device 115 of the motor vehicle 105 can be updated. The control device 115 can be updated before, during or after the updating of the vehicle key 110. It should be observed that the control device 115, under certain circumstances, can also be updated independently of the vehicle key 110.

The method 200 can also be employed for the updating of multiple vehicle keys 110 of the motor vehicle 105. The steps indicated, in particular 215, 225, 235 and 240, can be executed separately for each of the vehicle keys 110. Here again, a synchronization is possible. According to one embodiment, a transition to a subsequent step is only executed in the event that a process step has been successfully executed for all the vehicle keys 110. If one vehicle key 110 is unable to complete one of the steps, the updating process for all the remaining vehicle keys 110—and optionally of the control device 115—can be interrupted. According to another embodiment, process steps for the vehicle keys 110 are executed in a mutually independent manner. In the event that it is not possible for one of the vehicle keys 110 to be updated, it is thus possible that there is no resulting consequence for another vehicle key 110.

In the event of the failure of the updating of a vehicle key 110—or of an updating of the control device 115 which is dependent thereupon—, updating of the vehicle key or keys 110 can be cancelled. A switchback can thus be completed to program code which was successfully executed by the vehicle key 110 prior to the update. The control device 115, in a known manner, can be restored to the preceding state. The functional capability of the motor vehicle 105 can thus be maintained by the user 120, even in the event of the failure of updating.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE NUMBERS

100 System
105 Motor vehicle
110 Vehicle key
115 Control device
120 User
125 Updating service
130 Processing unit
135 Wireless interface
140 Memory
145 On-board interface
150 Processing unit
155 Wireless interface
160 First memory
165 Second memory
170 Energy storage device
200 Method
205 Reception of data updates by the motor vehicle
210 Preparation of control device for updating
215 Saving of data updates for the vehicle key
220 Detection of a first predetermined motor vehicle state
225 Communication of data updates to the vehicle key
230 Detection of a second predetermined motor vehicle state
235 Vehicle key ready?
240 Updating of vehicle key
245 Updating of control device

What is claimed is:

1. A method for updating an electronic vehicle key for a motor vehicle, comprising:
providing data updates for the vehicle key on board the motor vehicle;
transmitting data updates from the motor vehicle to the vehicle key via mutual wireless communication within a predetermined distance from one another;
determining an assumption by the motor vehicle of a state in which the vehicle key will foreseeably remain within the predetermined distance; and
updating the vehicle key.

2. The method of claim 1, wherein the predetermined distance encompasses an interior of the motor vehicle, and wherein it is determined that the vehicle key is located in the interior.

3. The method of claim 1, wherein it is determined that the vehicle key is situated in a predetermined location in the motor vehicle.

4. The method of claim 1, wherein the state comprises a travel of the motor vehicle at a predetermined minimum speed.

5. The method of claim 1, wherein the vehicle key comprises: a first memory storing program code for controlling the vehicle key, and a second memory storing data updates, and wherein the updating comprises a switchover from the first memory to the second memory.

6. The method claim 1, wherein it is determined on the vehicle key side that a cryptographic signature of the data updates is valid.

7. The method of claim 1, wherein it is determined that an energy storage device of the vehicle key assumes a predetermined performance capability.

8. The method of claim 1, wherein a control device of the motor vehicle is updated in a synchronized manner with the vehicle key.

9. The method of claim 1, wherein it is determined that a further vehicle key for the motor vehicle is situated within the predetermined distance, and wherein the further vehicle key is also updated.

10. An on-board control device of a motor vehicle, comprising:
a data supply unit configured to supply data updates for an electronic vehicle key for the motor vehicle;
a wireless interface for communicating with the vehicle key over a predetermined distance; and
a processing unit configured to:
communicate data updates to the vehicle key,
determine an assumption by the motor vehicle of a predetermined state in which the vehicle key will foreseeably remain within the predetermined distance, and
communicate an updating signal to the vehicle key.

11. The control device of claim 10, wherein the processing unit is configured to determine the assumption by the motor vehicle of a further predetermined state before data updates are communicated to the vehicle key.

12. A motor vehicle, comprising:
the control device of claim 10.

13. An electronic vehicle key, comprising:
a wireless interface configured to communicate with the motor vehicle over a predetermined distance, wherein the vehicle key wirelessly controls a predetermined security function of a motor vehicle via the wireless interface;
a memory storing program code for controlling the vehicle key; and
a processing unit configured to:
receive data updates for the vehicle key,
receive an updating signal from the motor vehicle, and
update program code based on the received data updates.

14. A system, comprising:
a motor vehicle having an on-board control device of a motor vehicle, wherein the control device includes:
a data supply unit configured to supply data updates for an electronic vehicle key for the motor vehicle,
a wireless interface for communicating with the vehicle key over a predetermined distance, and
a processing unit configured to:
communicate data updates to the vehicle key,
determine an assumption by the motor vehicle of a predetermined state in which the vehicle key will foreseeably remain within the predetermined distance, and
communicate an updating signal to the vehicle key; and
the electronic vehicle key of claim 13.
